(19) United States
(12) Patent Application Publication
(10) Pub. No.: US 2025/0238609 A1
(43) Pub. Date: Jul. 24, 2025

(54) TECHNIQUES FOR COMPUTER-BASED SYSTEMATIC LITERATURE REVIEW

(71) Applicant: ECNE Research, LLC, St. Petersburg, FL (US)

(72) Inventors: Elizabeth WEATHERS, St. Petersburg, FL (US); Thomas HOPKINS, St. Petersburg, FL (US); Samy ATEIA, St. Petersburg, FL (US)

(21) Appl. No.: 18/617,211

(22) Filed: Mar. 26, 2024

Related U.S. Application Data
(60) Provisional application No. 63/622,127, filed on Jan. 18, 2024.

(51) Int. Cl. G06F 40/20; G06F 16/35; G06F 16/383

(52) U.S. Cl. CPC G06F 40/20; G06F 16/35; G06F 16/383

(57) ABSTRACT

Computer-based techniques for performing systematic literature reviews are provided. Some embodiments include an SLR system including various components that interoperate to generate regulation-compliant SLR reports regarding an issue based on user-defined parameters. In several embodiments, the SLR system may integrate various artificial intelligence techniques to facilitate generation of SLR reports. For example, various SLR systems disclosed hereby may utilize generative pre-trained transformers to assist in aspects of systematic literature reviews, such as literature database queries, literature screening, data question generation, level of evidence classification, qualitative assessments, data extraction, and report generation.

### CROSS-REFERENCE TO RELATED APPLICATION

This application claims the benefit of and priority to U.S. Provisional Patent Application No. 63/622,127 filed Jan. 18, 2024. The entirety of which is incorporated herein by reference.

### FIELD OF DISCLOSURE

This disclosure relates generally to literature reviews and more particularly to computer-based techniques for performing systematic literature reviews.

### BACKGROUND

Systematic literature reviews, also referred to as systematic reviews, evidence synthesis, or meta-synthesis, generally refer to scholarly synthesis of the evidence on a defined topic using critical methods to identify, define, and assess research on the topic. A systematic review may extract and interpret data from published studies on the topic, then analyze, describe, critically appraise, and summarize interpretations into a refined evidence-based conclusion. For example, a systematic review of randomized controlled trials can be a way of summarizing and implementing evidence-based medicine and clinical practice.

While a systematic review is frequently applied in the biomedical or health care context, it may also be used where an assessment of a defined subject can advance understanding in a field of research. A systematic review may examine a variety of types and sources of data, such as one or more of clinical tests, public health interventions, environmental interventions, social interventions, adverse effects, qualitative evidence syntheses, methodological reviews, policy reviews, and economic evaluations. Systematic reviews are typically designed to provide a thorough summary of current literature relevant to a research question. They utilize a rigorous and transparent approach for research synthesis, with the aim of assessing findings while minimizing bias.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an exemplary operating environment for a systematic literature review (SLR) system according to some embodiments.

FIG. 2 illustrates an exemplary process flow for performing an SLR according to some embodiments.

FIG. 3 illustrates various aspects of an SLR system according to some embodiments.

FIGS. 4A and 4B illustrate a process flow for an SLR system according to some embodiments.

FIG. 5 illustrates various aspects of generating training data and artificial intelligence (AI) models for SLR systems according to some embodiments.

FIG. 6 illustrates a process flow for data extractions by an SLR system according to some embodiments.

FIG. 7 illustrates exemplary aspects of a computing system according to some embodiments.

FIG. 8 illustrates exemplary aspects of a communications architecture according to some embodiments.

### DETAILED DESCRIPTION

Various embodiments are generally directed to computer-based techniques for performing systematic literature reviews. Some embodiments are particularly directed to an SLR system including various components that interoperate to generate regulation-compliant SLR reports regarding an issue based on user-defined parameters. In several embodiments, the SLR system may integrate various artificial intelligence techniques to facilitate generation of SLR reports. For example, various SLR systems disclosed hereby may utilize generative pre-trained transformers to assist in aspects of systematic literature reviews, such as literature database queries, literature screening, data question generation, level of evidence classification, qualitative assessments, data extraction, and report generation. These and other embodiments are described and claimed.

Many challenges are faced when performing systematic literature reviews, such as resource intensive, subjectivity, and inaccurate systematic literature reviews. One or more of these challenges result from systematic literature reviews requiring a number of specific tasks that can only be performed subjectively by humans using existing techniques, such as screening, reviewing, labeling, analyzing, and extracting information from records (e.g., articles, papers, etc.). For example, in existing techniques, a human reviewer first looks at all abstracts and titles of the records returned by a prior specified search. They then decide which of these studies should be passed on to a later full-text screening. In the case of a disagreement between reviewers, a third reviewer looks at the specific study and passes a final judgement. Further, the eligibility criteria that guide the inclusion and exclusion decision of the human reviewers are defined beforehand in a review protocol and necessarily applied in a subjective manner by the human reviewers. Adding further complexity, existing AI techniques often provide incorrect or misleading information, which can be due to AI hallucinations. Further, it is technically infeasible to determine how or why an AI model came to an output. Such limitations can drastically reduce the usability and applicability of existing systematic literature reviews, contributing to inefficient systems, devices, and techniques with limited capabilities.

Various embodiments described hereby include a computer-based SLR system that can be utilized in an intuitive manner to combine information from multiple studies investigating a topic to produce an SLR report that comprehensively presents findings on the topic in an efficient, reliable, and accurate manner. For example, these findings may inform interested parties as to the effectiveness of a particular treatment or drug, or how people have experienced a particular health condition or treatment. To this end, the SLR systems disclosed hereby can automate and improve one or more of the design, implementation, publishing, and dissemination of clinical evidence, such as through the use of various artificial intelligence techniques. In many embodiments, the SLR systems can integrate text extractions, AI-powered text generation, and results compilation in a seamless pipeline. The text segmentation approach is designed to handle a variety of records (e.g., academic papers, articles, studies, etc.) with different formatting systems and section titles, making it versatile and adaptable. The use of AI to generate responses to specially engineered prompts based on segmented text provides an efficient, effective, and accurate approach to automating literature review and data extraction. Further, the SLR systems can leverage domain specific knowledge about the structures of scientific publications. The SLR systems may limit, or enable users to limit, the relevant context for a data extraction question to specific sections of the records, such as “Methods”, “Conclusion”, “Results”, to reduce the introduction of additional potentially noisy data to the AI model that could lead to incorrect outputs. By carrying out evidence synthesis in such an efficient, reliable, and accurate manner, policymakers, healthcare institutions, clinicians, researchers, regulatory bodies, and the public can make more informed decisions about health and healthcare, and the safety and performance of medical technologies, drug therapies, and/or therapeutic interventions.

Accordingly, the SLR systems disclosed hereby can at least improve the technical field of evidence synthesis, such as by providing a streamlined and faster approach for literature reviews, driving faster regulatory approval and clinical adoption of groundbreaking medical technologies, and ultimately improving care and outcomes for patients, clinicians, and institutions. Many of these improvements are supported by new and useful computer functionality described hereby. For example, the SLR system may automate aspects of determining database queries for identifying related studies. In another example, the SLR system may automate various aspects of screening related studies to identify relevant studies to utilize in generating an SLR report. In yet another example, the SLR system may automate aspects of determining effective data questions and extracting answers to the data questions from the relevant studies in a manner that achieves the objective for a topic of a systematic literature review. In still another example, the SLR system may accurately and efficiently perform level of evidence classifications and qualitative assessments of relevant studies to ensure accuracy and an adequate basis for information provided by studies. In yet another example, the SLR system may utilize extracted answers, evidence classifications, and qualitative assessments to generate reliable, comprehensive, and informative SLR reports that achieve the objective of a systematic literature. In yet another example, the SLR system may implement the systematic literature review in a set of discrete steps with various outputs that give valuable insights to how and why outputs are determined. In still another example, the SLR system may continually improve outputs based on user inputs using an active learning process.

Thus, the components/techniques of the SLR systems may be utilized to, among other things, provide a practical solution to the time-consuming task of manual literature review and data extraction. By automating and/or assisting with aspects of the process, the SLR systems can save time, reduce risks of human error, and enable the processing of a large number of records in a short amount of time. Further, AI is utilized in a manner that ensures the extracted information is comprehensive and accurate, while the output of the SLR system makes the results easily accessible and available for further analysis. In these and other ways, the components/techniques described hereby result in several technical effects and advantages over conventional computer technology, including increased capabilities, improved computer functionality, and better performance, resulting in a practical application. For example, the SLR systems may enable the automation of specific tasks that previously could only be performed subjectively by humans, such as screening or data extraction in systematic literature reviews. In another example, the AI techniques described hereby integrally utilize one or more machines to achieve performance of a technique and play a significant part in permitting the technique to be performed, such as a machine specially and extensively trained to generate and/or implement a large language model. In yet another example, an improved user interface for electronic devices may display information or summaries regarding suggested inputs that may be selected to one of the suggested inputs. Additional examples will be apparent from the detailed description below. Further, one or more of the aspects, techniques, and/or components described hereby may be utilized to improve the technical fields of systematic literature review, artificial intelligence, prompt engineering, data analysis, and user interfaces.

In several embodiments, components described hereby may provide specific and particular manners to enable the techniques and functionalities described hereby. In many embodiments, one or more of the components described hereby may be implemented as a set of rules that improve computer-related technology by allowing a function not previously performable by a computer that enables an improved technological result to be achieved. For example, the function allowed may include one or more of automating aspects of systematic literature review or surfacing of relevant data, functionalities, and/or suggested inputs. Additional examples will be apparent from the detailed description below.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, structures and devices are shown in block diagram form in order to facilitate a description thereof. The intention is to cover all modifications, equivalents, and alternatives consistent with the claimed subject matter. Aspects of the disclosed embodiments may be described with reference to one or more of the following figures. Some of the figures may include a logic flow and/or a process flow. Although such figures presented herein may include a particular logic or process flow, it can be appreciated that the logic or process flow merely provides an example of how the general functionality as described herein can be implemented. Further, a given logic or process flow does not necessarily have to be executed in the order presented unless otherwise indicated. Moreover, not all acts illustrated in a logic or process flow may be required in some embodiments. In addition, a given logic or process flow may be implemented by a hardware element, a software element executed by a processor, or any combination thereof.

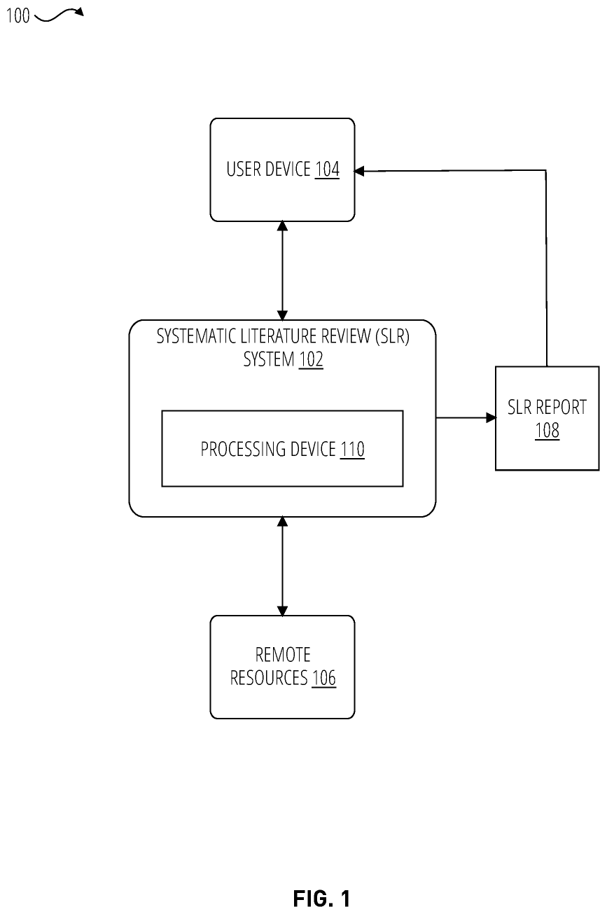

FIG. 1 illustrates an operating environment 100 for an SLR system 102 according to some embodiments. The operating environment 100 includes the SLR system 102, a user device 104, one or more remote resources 106, and an SLR report 108. In various embodiments described hereby, the SLR system 102 may utilize input provided via the user device 104 in combination with data obtained from the one or more remote resources 106 to generate the SLR report 108 in an accurate, reliable, and efficient manner that complies with applicable regulations. In various such embodiments, the SLR system 102 may utilize various artificial intelligence techniques to generate SLR reports. It will be appreciated that one or more components of FIG. 1 may be the same or similar to one or more other components disclosed herein. Further, aspects discussed with respect to various components in FIG. 1 may be implemented by one or more other components from one or more other embodiments without departing from the scope of this disclosure. For example, one or more functionalities provided by remote resources 106 may be integrated into the SLR system 102 without departing from the scope of this disclosure. Embodiments are not limited in this context.

In various embodiments, the SLR system 102 may automate and improve one or more of the design, implementation, publishing, and dissemination of clinical evidence. Accordingly, the SLR system 102 may be utilized to drive faster regulatory approval and clinical adoption of groundbreaking medical technologies, and ultimately improve care and outcomes for patients, clinicians, and institutions. More generally, systematic reviews, sometimes referred to as evidence synthesis, performed by SLR systems disclosed hereby may combine information from multiple studies investigating a topic to comprehensively understand findings on the topic. For example, this may include determining how effective a particular treatment or drug is, or how people have experienced a particular health condition or treatment. By carrying out evidence synthesis in an effective and efficient manner, policymakers, healthcare institutions, clinicians, researchers, regulatory bodies, and the public can make more informed decisions about health and healthcare, and the safety and performance of medical technologies.

In various embodiments described hereby, a systematic review may include a review that uses a systematic method (i.e., review protocol) to summarize evidence on a specific topic or question. The systematic method can utilize a detailed and comprehensive plan of study to frame and answer a clinical or health care related question. For example, SLR system 102 may implement a systematic method that utilizes at least one of a PICO, SPICE, or PECO process. The PICO process may correspond to patient, problem, or population (P), intervention (I), comparison, control, or comparator (C), and outcome (O). The SPICE process may correspond to setting(S), perspective (P), intervention/exposure/interest (I), comparison (C), and evaluation (E). The PECO process may correspond to population (P), exposure (E), comparison (C), and outcome (O). In some systematic methods timing (T) and/or study type(S) may be included. Timing may refer to the duration of intervention or date of publication. Examples of study type may include randomized controlled trial, cohort study, etc. In many embodiments, the systematic method may be predefined, determined based on user input, and/or determined based on characteristics of the included studies.

The SLR system 102 may operate in conjunction with user device 104 and/or one or more remote resources 106 to perform systematic literature review projects, also referred to as projects. For example, input may be provided and output may be presented via user device 104. Additionally, the SLR system 102 may interact with one or more remote resources 106 to perform projects. For example, remote resources 106 may include one or more databases and/or one or more artificial intelligence resources. In many embodiments, the SLR system 102 may utilize various artificial intelligence techniques to automate and/or assist in one or more aspects of performing a systematic literature review, also referred to as a project. For example, SLR system 102 may be utilized in one or more of designing a search strategy, searching selected electronic databases, screening the records (e.g., articles, papers, etc.) sourced for inclusion, extracting relevant data from the records, and drafting a summary report (e.g., SLR report 108). Integration of AI can increase speed and efficiency of systematic reviews without compromising quality.

Additionally, many embodiments include a user interface (e.g., presented via user device 104) that can be used to generate interactive real-time systematic literature reviews in which a user can retain oversight of search parameters. In various embodiments, the techniques disclosed hereby may result in an improved user interface for electronic devices that displays information, functionalities, or summaries regarding various aspects of a systematic literature review. For example, information utilized in previously performed aspects of systematic literature reviews and/or statistics regarding such information may be presented and users may be able to select the information to activate functionality that implements the information in the current systematic literature review. In one example, the SLR system 102 may determine usage statistics of previous record queries along with functions to implement selected ones of the previous record queries.

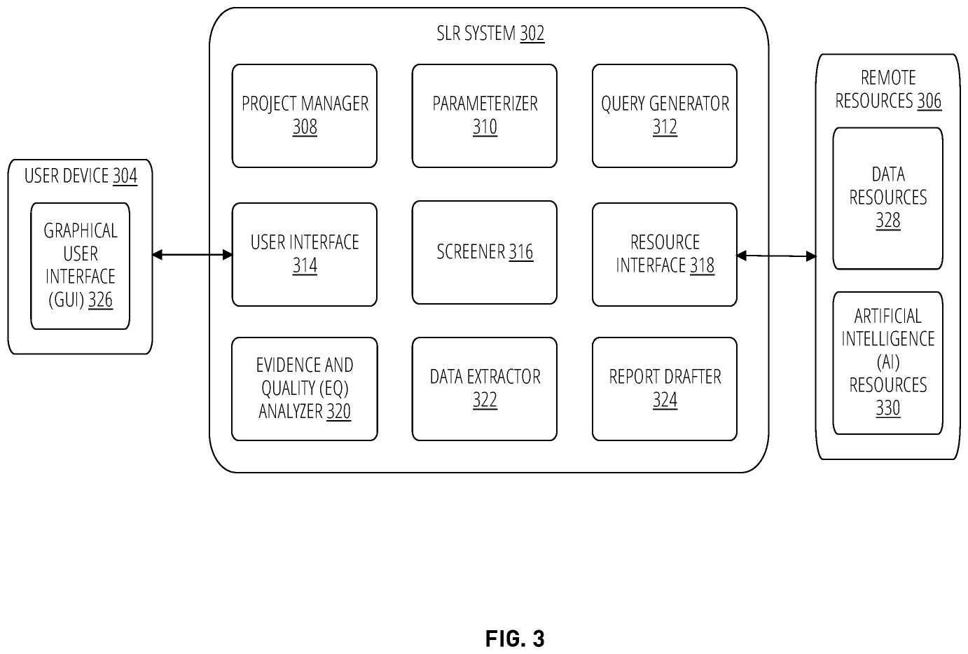

In many embodiments, the processing device 110 may implement one or more functional modules (e.g., by executing instructions stored on a computer-readable medium) to perform the techniques described hereby. It should be noted that although a single processing device 110 is depicted in FIG. 1 for simplicity, other embodiments may include multiple processing devices, storage devices, or devices. Processing device 110 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 110 may also include one or more special-purpose processing devices such as an application specific integrated circuit (ASIC), a field programmable gate array (FPGA), a digital signal processor (DSP), network processor, a graphics processing unit (GPU), or the like. Further details regarding various functional modules implemented by processing device 110 to perform the techniques described hereby are described in more detail below, such as with respect to FIG. 3. However, these functional modules should not be interpreted as limiting and a variety of additional or different functional modules may be implemented by processing device 110 without departing from the scope of this disclosure.

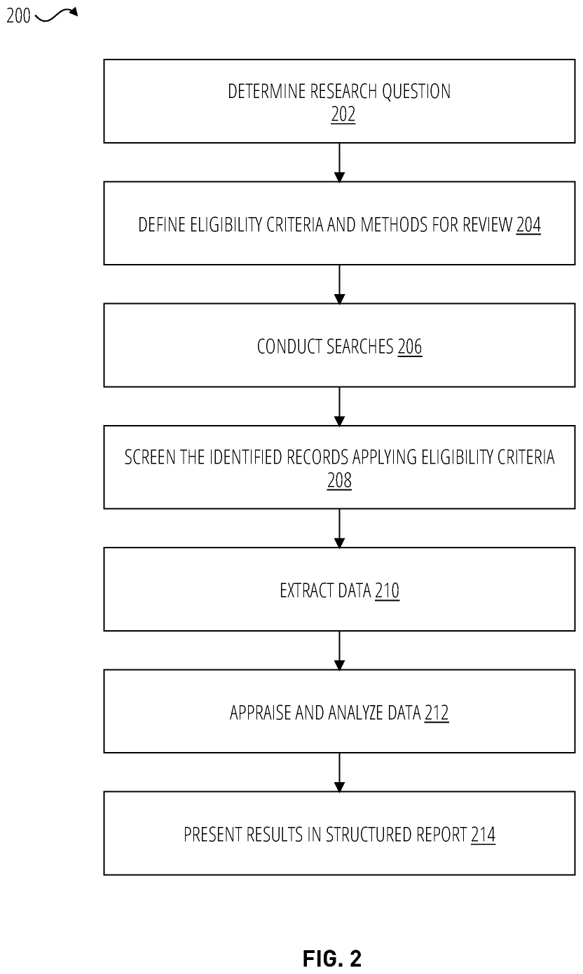

FIG. 2 illustrates a process flow 200 for performing a systematic literature review according to some embodiments. The process flow 200 illustrates high-level exemplary steps performed, such as by SLR system 102, during a systematic literature review project. Aspects of these steps are described in more detail with respect to subsequent figures. The process flow 200 may be performed by processing logic that may include hardware and/or control logic (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of process flow 200 may be performed by one or more components of SLR system 102, such as processing device 110. Embodiments are not limited in this context.

With reference to FIG. 2, process flow 200 illustrates example functions used by various embodiments. Although specific function blocks (“blocks”) are disclosed in process flow 200, such blocks are examples. That is, embodiments are well suited to performing various other blocks or variations of the blocks recited in process flow 200. It is appreciated that the blocks in process flow 200 may be performed in an order different than presented, and that not all of the blocks in process flow 200 may be performed.

Process flow 200 begins at block 202, where a research question is determined. For example, the research questions for a systematic literature review project may be determined based on user input provided to SLR system 102, such as via user device 104. For example, the research question, or aim of a project, may include “What does existing research indicate regarding the prevalence childhood bereavement?”. In some embodiments, determining the answer to the research question along with supporting information may be the objective of a systematic literature review project. Proceeding to block 204, eligibility criteria and methods for review may be determined. For example, user input may be received at SLR system 102 identifying the eligibility criteria and methods for review. The methods for review may refer to, or include, the review protocol. In some embodiments, as discussed in more detail below, eligibility criteria may include one or more parameters and/or thresholds for performing a systematic literature review project. For example, threshold confidence levels, threshold levels of evidence, and the like may be identified for utilization in determining whether to include or exclude records from a project.

Continuing to block 206, searches may be conducted. For example, various databases may be searched to identify related records (e.g., papers, articles, studies, etc.). In some embodiments, the databases to be searched may be determined based on user input. In various embodiments, the SLR system 102 may generate one or more queries aimed at identifying records related to the research questions in view of the known parameters of the project (e.g., eligibility criteria, methods, etc.). In various such embodiments, generated queries may be presented via a user interface for review, modification, and/or approval. At block 208 the identified records may be screened by applying the eligibility criteria. For example, records that do not meet various eligibility criteria may be removed from the result. In various embodiments, screening may be an interactive process in which screening decisions may be rejected, modified, and/or approved, such as via user device 104. The related records remaining after the screening process may be referred to as relevant records. In some embodiments, determination of relevant records may utilize few-shot learning in a collaborative active-learning scenario where the few-shot examples are determined iteratively based on user input.

Proceeding to block 210, data may be extracted. For example, the data may be extracted from each of the relevant records. In several embodiments, the extracted data may include answers to various questions regarding the project. For example, the questions may include “What is the aim of the study?” and/or “What are the findings on prevalence of childhood bereavement?”. At block 212, the data may be appraised and analyzed. For example, level of evidence classification and/or qualitative assessments of the records may be performed. In some embodiments, qualitative assessments may evaluate the methodological quality of a record. Continuing to block 212 the results may be presented in a structured report. For example, the results may be presented as an SLR report 108 on user device 104.

FIG. 3 illustrates various aspects of an SLR system 302 according to some embodiments. In the illustrated embodiment, SLR system 302 is communicatively coupled to a user device 304 and one or more remote resources 306. The SLR system 302 may include a project manager 308, a parameterizer 310, a query generator 312, a user interface 314, a screener 316, a resource interface 318, an evidence and quality (EQ) analyzer 320, a data extractor 322, and a report drafter 324. The user device 304 may include a graphical user interface (GUI) 326. The remote resources 306 may include one or more data resources 328 and one or more artificial intelligence (AI) resources 330. In various embodiments, the components of SLR system 302, user device 304, and/or remote resources 306 may interoperate with each other to perform a systematic literature review of a specific issue (e.g., topic or question). It will be appreciated that one or more components of FIG. 3 may be the same or similar to one or more other components disclosed herein. For example, SLR system 302 may be the same or similar to SLR system 102. Further, aspects discussed with respect to various components in FIG. 3 may be implemented by one or more other components from one or more other embodiments without departing from the scope of this disclosure. For example, one or more of the AI resources 330 may be incorporated into one or more components of SLR system 302, such as query generator 312, screener 316, EQ analyzer 320, data extractor 322, or report drafter 324, without departing from the scope of this disclosure. Embodiments are not limited in this context.

The SLR system 302 may be communicatively coupled with the user device 304 via user interface 314. In various embodiments, the user device 304 may receive input for and present output from the SLR system 302 via the GUI 326. In various such embodiments, the user interface 314 may generate instructions to cause the user device 304 to render the GUI 326, such as for displaying and requesting various information on the user device 304. More generally, various components of the SLR system 302 may operate in conjunction with user interface 314 to receive input or provide output via GUI 326 of user device 304. Further, the user interface 314 may format, transform, or package data in a manner that can be readily utilized by the user device 304, such as for display via GUI 326. Further, relevant and useful information and functionalities may be surfaced and presented via the GUI 326 to provide an improved user interface. Generally, the GUI 326 may enable the creation of projects and that helps to guide users through multiple steps of the process. The SLR system 302 may support multiple concurrent users working on different stages of the project (e.g., via multiple GUIs on multiple device). The GUI 326 may present search results from public databases, but also offer the possibility to manually upload and add individual records (e.g., as PDFs or RIS, RDF or similar files), such as from tools that help organize scientific publications.

Similarly, the SLR system 302 may be communicatively coupled with the remote resources 306 via resource interface 318. In some embodiments, the resource interface 318 may generate inputs and receive outputs from one or more of the remote resources 306, such as data resources 328 or AI resources 330. In various embodiments, the resource interface 318 may format, transform, or package data (e.g., in a data packet) in a manner that can be readily utilized by the remote resources 306.

The project manager 308 may operate to perform managerial and administrative duties with respect to various systematic literature reviews performed by the SLR system 302, which may be referred to as projects. For example, the project manager 308 may verify users, such as via login credentials. In another example, the project manager 308 may provide functionality that enables a user to create a new project. In yet another example, the project manager 308 may enable parameters, projects, and/or states to be saved or loaded. In another example, project manager 308 may enable template projects to be created to serve as a starting point or configuration for future projects. In some embodiments, the project manager 308 may provide user workspaces for different users. The parameterizer 310 may determine various parameters, such as based on user input, of a project to be performed by the SLR system 302. For example, parameterizer 310 may determine the aim of a project, the review protocol, the data resources (e.g., databases) to use in performing a project. In another example, the parameterizer 310 may determine various thresholds to use in a project, such as threshold confidence levels, threshold levels of evidence, and the like.

The query generator 312 may operate to determine queries for use in identifying related records in the data resources 328. The query generator 312 may generate one or more queries for determining related records. These queries may be determined by the question generator based on various parameters of a project, such as the review protocol, objective, topic. In many embodiments, the query generator 312 may utilize an AI model (e.g., a large language model or generative pretrained transformer) for generating the queries. Additionally, the query generator 312 may enable a user to review and/or revise queries, such as via GUI 326.

In many embodiments, the screener 316 may operate to select a set of relevant records (e.g., studies, articles, etc.) from the set of related records identified in data resources 328 that should be included in the systematic review in an accurate, comprehensive, and efficient manner that removes or prevents subjectivity introduced by human reviewers. For example, the screener 316 can automate the review and labeling of records for inclusion or exclusion, reducing the need for manually performed tasks. In various embodiments, the screener 316 may transform and/or integrate prior knowledge, such as a description of the review topic, purpose, and/or objective, a review protocol, or user inputs, in a structured format (e.g., list of questions) that can be used with generative large language models to summarize and extract relevant information from records and use this information in both a single pass and active learning loop for classification. In various embodiments, the screener 316 may add metadata (e.g., date, answers to PICOS questions, extracted features for ranking, etc.) to the presentation of individual studies. This metadata may be presented via the GUI 326. The screener 316 may include multiple different sub-components. For example, the screener 316 may include one or more of a screening question generator, a screening question answer generator, a record classifier and ranker.

The screening question generator may generate a set of relevant questions that should be answered about each record to determine if the studies should be included or excluded from the review. These questions may be determined by the question generator based on various parameters of a project, such as the review protocol, objective, topic. For example, the set of relevant questions may include “Is the study a randomized control trial?”. Further, each question may utilize a rating schema that advises how answers should be interpreted. For example, the rating schema may include yes (Y), partially yes (PY), no (N), and partially no (PN) with P and PY indicating inclusion and N and PN indicating exclusion. In some embodiments, PY and PN may trigger a secondary manual review, such as via GUI 326. The question generator may present one or more of the set of relevant questions to a user (e.g., via GUI 326) in a manner that allows the user to confirm and/or adjust the set of relevant questions.

The set of relevant questions along with one or more sections (e.g., abstract and title) of the related, or potentially relevant, studies identified in data resources 328 may be provided to the screening question answer generator. The screening question answer generator may iterate over the related records to generate answers to the set of relevant questions for each of the related records. Thus, the screener 316, among other components of the SLR system 302, can automate and simplify aspects of systematic literature reviews, such as classification of related studies. Additionally, when manual review is performed, it can be performed in a more efficient manner due to automated identification of relevant information from studies. In many embodiments, the screening questions answer generator may utilize an AI model, such as a generative pretrained transformer model, to produce answers to the screening questions. In some embodiments, the AI model may be included in AI resources 330. Accordingly, screener 316 may utilize resource interface 318 to provide input (e.g., the set of relevant questions along with one or more sections) and receive output (e.g., the answers) from the AI model.

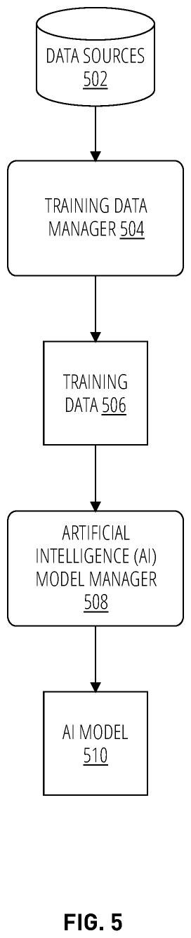

The record classifier and ranker may utilize the questions, generated answers, and the rating schema to make decisions on whether or not each of the related records should be included or excluded from the review. As part of this process, the record classifier and ranker may assign confidence levels, or confidence scores, to each inclusion/exclusion decision. For example, the confidence levels may be based on the previously described rating schema and/or the relevance of answers to the topic or objective of the literature review. In one embodiment, the confidence levels may correspond to probabilistic uncertainty measure supplied by the AI model in conjunction with generated output. In some embodiments, various thresholds and/or rules may be utilized to determine whether to include or exclude a record. For example, if a record is not a randomized control trial, it may be excluded and/or assigned a low confidence score. In another example, if the population examined by the record is not of a threshold size, the record may be excluded and/or assigned a low confidence score. In various embodiments, the record classifier may refer some records for manual review, such as records with low classification scores. Records for manual review may be presented via GUI 326. Further, the GUI 326 may enable manual reclassification and/or reranking. Additionally, input provided via manual reviews may be utilized to improve future determinations by the screener 316 and more generally, manual input provided at any stage of the systematic literature review may be utilized to improve future determinations by the SLR system 302 using an active learning process, such as via background implementation of reinforcement learning from human feedback. In some embodiments, manual input may be utilized to revise training data and the revised training data may be utilized to produce a new AI model. In a further such example, the screener 316 may perform another ranking pass and a reclassification after the input is provided to add a different label (e.g., switch exclude to include). Various aspects of generating AI models utilized by various SLR systems disclosed hereby are described in more detail below, such as with respect to FIG. 5.

The EQ analyzer 320 may perform level of evidence classifications and qualitative assessments of relevant studies to ensure accuracy and an adequate basis for information provided by records. For example, level of evidence may include, or refer to, a hierarchy of classifications that indicate the trustworthiness of information provided in a record. In some embodiments, the hierarchy of classifications from most trustworthy to least may include: (a) meta-analyses; (b) systematic reviews; (c) randomized controlled trials; (d) cohort studies; (e) case control studies; (f) cases series or case reports; (g) expert opinion; and (h) animal research or in vitro studies. Further, the qualitative assessment of a record may include an evaluation of one or more of the framework (e.g., conceptual/theoretical), interpretations, conclusions, assumptions, source of the record, and the like. In many embodiments, the qualitative assessment may determine a quality score of a record. For example, the qualitative assessment may evaluate and assign a score to the methodological quality of a record. In an additional, or alternative, example, bias in aspects of a record may result in a lower quality score. Accordingly, qualitative assessments may identify, rate, and/or document risks of bias associated with a record. In various embodiments, the EQ analyzer 320 may utilize one or more AI models to perform the level of evidence classifications and/or qualitative assessments. In many embodiments, filtering of records may be performed based on the qualitative and/or level of evidence classifications. For example, records that have qualitative and or level of evidence classification scores below a threshold may be excluded.

In various embodiments, the data extractor 322 may operate to extract, analyze, and interpret data from a collection of records (e.g., papers, articles, publications, reports, etc.) and present the results in an easily accessible format, such as a table or spreadsheet. In various such embodiments, the collection of records may include the records identified based on queries generated by query generator 312 and then screened by screener 316. The data extractor 322 may utilize AI to read, comprehend, and summarize the content of the collection of records.

The data extractor 322 may receive the collection of records, a list of concepts to extract, and indications from where to draw the information as inputs. In some embodiments, the collection of records may be provided to the data extractor 322 as folder of files. In some such embodiments, the folder of files may include a folder of full-text pdf files. The indications from where to draw the information may correspond to a normalized set of sections or segments in a record, such as title page, abstract, introduction, methods, results, discussion, conclusions, and the like. In one or more embodiments, the normalized set of sections may be predefined or defined by a user.

The data extractor 322 may iterate over each record in the collection and extract the full text from them. The data extractor 322 may then split the full text into sections that are normalized and later selected according to the section indications provided in conjunction with a concept (e.g., data question). An example of a concept to extract along with indications from where to draw the information may include the following: “What is the aim of the study?” [“title_page”, “introduction”], where title page and introduction are indications from where to draw the information. Another example of a concept to extract along with indications from where to draw the information may include the following: “What are the findings on Prevalence of Childhood Bereavement?” [“title_page”, “results”, “discussion”, “conclusions”], where title page, results, discussion, and conclusions are indications from where to draw the information. The indications may serve to limit the context that is considered by the model, which can reduce possible errors. For example, limiting the context to the title page can prevent the AI model from mistakenly identifying authors of references in a record as authors of the record.

The data extractor 322 may package the concept along with the full text of the indicated sections into a prompt that is provided as input to an AI model, such as a large language model and/or generative pretrained transformer model. The prompt may be specifically engineered to produce accurate and reliable results from the AI model in an appropriate format, such as through one or more of phrasing of the query, specifying a style, providing relevant context, requesting reasoning used to arrive at an output, and assigning a role to the AI model. In various embodiments, chain or thought prompting may be utilized to improve outputs and identifying errors, such as in reasoning. In chain of thought prompting, the AI model may be asked to explain its reasoning used to arrive at an output. In some embodiments, the reasoning may be analyzed by the system to evaluate the validity of the output.

In various embodiments, different roles may be assigned based on the task at hand (e.g., different roles for different portions of the systematic literature review). The roles may be assigned by including a statement regarding the role in the prompt. As discussed in more detail below, the roles may be assigned using template language, such as a different template for each portion of the systematic literature review. Customizing the roles for the task at hand can considerably improve the performance of the AI model and cause the output to have a format and/or contents to readily facilitate computer-based interpretation of the output. For example, for screening the AI model should output uncertainty to enable filtering of the results (e.g., to exclude results below a threshold and/or flag certain results for manual review). Accordingly, in an exemplary embodiment, during screening the role may be assigned by including the following language in the prompt-“You are an expert researcher in the area of medical and care research. You are brilliant at conducting thorough analysis of research, but you are also able to express and explain uncertainty.” An example of a role assigned during level of evidence classification may include the following language in the prompt-“You are an expert systematic reviewer considered as the best in critically judging the level of evidence of a scientific publication in the biomedical field.” An example of a role assigned during level of evidence classification may include the following language in the prompt-“You are an expert systematic reviewer considered as the best in critically judging the level of evidence of a scientific publication in the biomedical field.” An example of a role assigned during data extraction may include the following language in the prompt-“As an expert in medical data extraction and analysis of studies”. In some embodiments, a role may not be included in a prompt.

In some embodiment, he AI model may utilize in-context learning, which refers to the ability of the model to learn from prompts, to produce the accurate and reliable results. In various embodiments, one or more template prompts may be utilized. For example, an optimal template prompt may be selected based on indications provided with the concept to extract. An example of a template prompt specifically engineered to produce accurate and reliable results is provided below.
def get_prompt(question:str, context:str)->str:
   return f““
   As an expert in Medical data extraction and analysis of studies, you are presented with the following context (delimited by triple backticks). Please analyze the context and answer the question that follows. If the information provided does not allow for a definitive answer, you *must* respond with ‘N/A’. Do not infer or create an answer that isn't supported by the context, you must only answer with *‘N/A’* if no information is relevant “‘{context}’”
Question: {question}
Please consider the information carefully and provide a relevant answer, with extracted supporting information:””

In the above template prompt, the {context} is replaced by the full text information from the indicated sections and the {question} is replaced with the relevant concept that should be extracted.

In many embodiments, the available prompt size or context size that can be input to the AI model may be limited (e.g., 4096 tokens (˜4-8 pages of text). Accordingly, if a resulting prompt is too large, the data extractor 322 may split the text into processable chunks and concatenate the answers extracted from prior text chunks with the subsequent context to generate the answer over the full content. In other words, a first prompt may correspond to a first section indication and a second prompt may correspond to a second section indication and the output generated from the first prompt may be concatenated with the output generated from the second prompt.

In some embodiments, during data extraction, the GUI 326 may enable a user to input the list of questions and an option to select relevant sections from which to extract the answers to the questions. Further, the GUI 326 may provide a preview view of the extraction on top of the records to enable tuning the questions. Further, the ability to view detailed and simplified version of the resulting extractions may be provided via GUI 326. Additionally, the GUI 326 may provide the ability for records to be exported, such as to a zip file or folder.

After each record in the collection is processed, the data extractor 322 may generate a file (e.g., table or spreadsheet) containing one row per record and one column per concept. Additionally, in various embodiments, the file may include columns corresponding to level of evidence classifications and qualitative assessments. In some embodiments, the file may facilitate further processing and/or manual review. An example of output extracted based on the example prompt and questions described above may include the following:

What is the aim of the study?

“The aim of the study is to examine the co-occurrence of adverse childhood experiences (ACEs) and positive childhood experiences (PCEs) by a history of childhood bereavement (CB) and its association with adult flourishing in a Chinese young adult sample.”

What are the findings on Prevalence of Childhood Bereavement?

“The findings on the prevalence of childhood bereavement are as follows:
Among the 9468 Chinese young adults (18-35 years) included in the study, 4.3% (n=409) reported experiencing childhood bereavement.
The participants self-reported exposure to the death of a mother, father, or guardian before the age of 18.
The prevalence of childhood bereavement was significantly higher among participants who reported being married or cohabitating (1.5%) compared to those who were single (0.5%).
The prevalence of childhood bereavement was also higher among participants who reported “other” marital status (20.1%) compared to other categories of marital status.”

In an exemplary table containing the above example, “What is the aim of the study?” may correspond to the header of a first column and the first response may be included in a cell where the first column intersects with a row corresponding to the record from which the first and second responses were determined. Similarly, “What are the finding on Prevalence of Childhood Bereavement?” may correspond to the header of a second column and the second response may be included in a cell where the second column intersects with the row corresponding to the record from which the first and second responses were determined.

In various embodiments, the data extractor 322 may include multiple different sub-components. For example, the data extractor 322 may include one or more of a text extractor, a text segmented, an AI prompt generator, an AI text generator, and a results compiler. The text extractor may read record files in the collection and extract raw text content. In various embodiments, the text extractor may read PDF record files and/or utilize a Python library. The text segmenter may divide the extracted text into different sections (e.g., applicable ones of the normalized set of sections) according to the structure of the records. In many embodiments, the segmentation process involves identifying section titles within the text and mapping them to predefined section names.

The AI prompt generator may utilize the segmented text to generate prompts for an AI model (e.g., generative pretrained transformer (GPT) model). The prompts are designed to ask specific questions related to the content of each section. In many embodiments, this may be achieved, at least in part, through prompt engineering as previously discussed. The AI text generator may include the AI model that generates responses to the prompts, which effectively summarize the relevant content of each section. In various embodiments, the prompt may be provided to a large language model included in AI resources 330 as input text. The input text may be split into n-grams encoded as tokens and each token is converted into a vector via using a word embedding table. At each layer of the model, each token may be contextualized within the scope of the context window with other (unmasked) tokens via a parallel multi-head attention mechanism allowing the signal for key tokens to be amplified and less important tokens to be diminished. The attention mechanism may mimic cognitive attention by calculating soft weights for each word or embedding in the context window. These weights can be computed either in parallel (such as in transformers) or sequentially (such as recurrent neural networks). The soft weights can change during each runtime, in contrast to hard weights, which remain the same after training and fine-tuning. The AI text generator responses may be treated as the answers to the questions posed in the prompts.

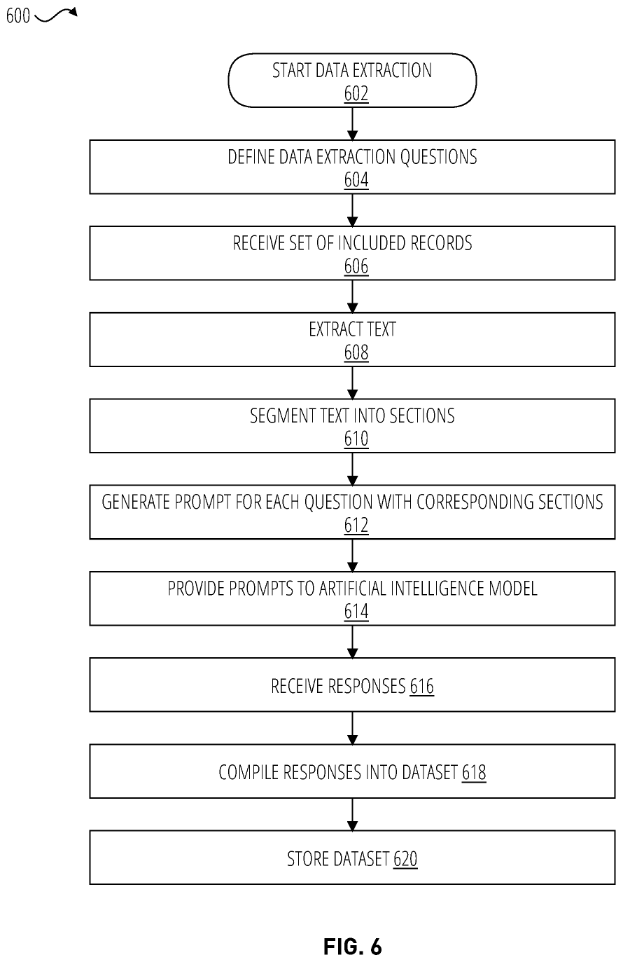

The results compiler may compile and organize the AI-generated answers according to the record file they came from and the question they answer. The results can then be saved to a table or spreadsheet file for easy review and analysis. In some embodiments, one or more of the sub-components of the data extractor 322 may be included in, or implemented by, another component of SLR system 302. For example, the AI prompt generator may be included in query generator 312. In another example, the AI text generator may be included in AI resources 330. In yet another example, the results compiler may be included in the report drafter 324. Various aspects of generating AI models utilized by various SLR systems disclosed hereby are described in more detail below, such as with respect to FIG. 5. Further, an exemplary process flow performed by data extractor 322 is described with respect to FIG. 6.

The report drafter 324 may utilize the compiled results to generate a final report. For example, the report drafter 324 may generate a final draft report based on the records augmented with data and assessments performed by various components of the SLR system 302 described below. In various embodiments, the report drafter 324 may utilize a template report that is completed based on the outputs of one or more of the EQ analyzer 320 and data extractor 322. For example, the table or spreadsheet file generated by data extractor 322 may be utilized to produce the report. In some embodiments, user input may be utilized to determine a template to utilize for the final report. In various embodiments, drafts of the final report may be presented to a user, such as via GUI 326. Additionally, user input may modify and revise the draft reports. In many embodiments, GUI 326 may provide an interface for users to upload and preview templates. In many such embodiments, the GUI 326 may enable selection of which data or columns to use to populate portions of the template. As previously discussed, these user inputs may be utilized to improve future draft reports.

Referring back to the qualitative assessment, an exemplary procedure for a qualitative assessment may include a first step that utilizes an AI model to determine answers to a set of questions, such as questions associated with a risk of bias. In a second step, the AI model may be utilized to provide a final judgment based on the answers and a rating schema. In a third step the results may be organized, such as based on the risk of bias and/or rating schema, and output. The formatted output may include a spreadsheet or text document.

In various embodiments, the set of questions may include a standardized set of questions grouped into domains (e.g., using the Cochrane risk-of-bias tool). Further, these questions may be incorporated into a specially engineered prompt to cause the AI model to assess the risk of bias and answer the set of questions based on provided details. Further, each answer may be selected from a preconfigured set of possible answers. Additionally, the answers may be configured into an array that readily facilitates further processing. An example question may include “1.1 Was the allocation sequence random? Response Options: Y/PY/PN/N/NI”.

In some embodiments, the rating schema utilized in the second step may include An exemplary prompt for the second step in the qualitative assessment may include: ‘Y’ and ‘PY’ indicating no or low risk of bias and ‘PN’ and ‘N’ indicating a risk of bias.

The procedure for a qualitative assessment described above first extracts relevant information before letting the AI model derive some answer based on this information. Such a two-step procedure may be utilized in various portions of a systematic literature review. Additionally, using prompts to supply the models with a specific set of instructions on how something should be determined (e.g., risk of bias) can be utilized to improve model performance and reduce errors. More generally, breaking complex abstract tasks down into simple question and answer tasks plus supplying the models with a fixed interpretation framework for these answers can be utilized to improve model output.

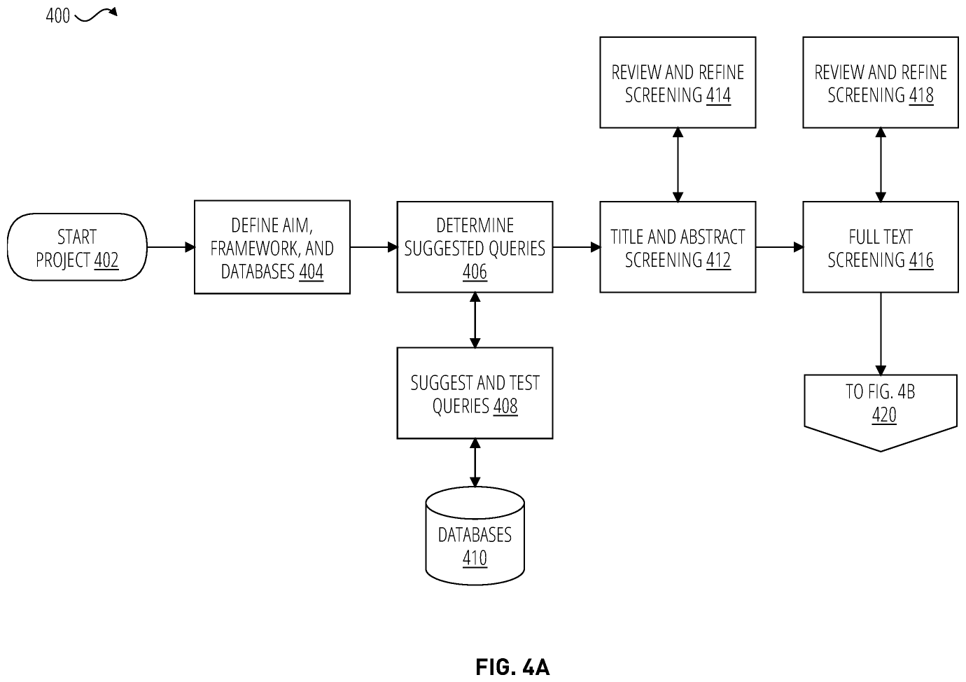

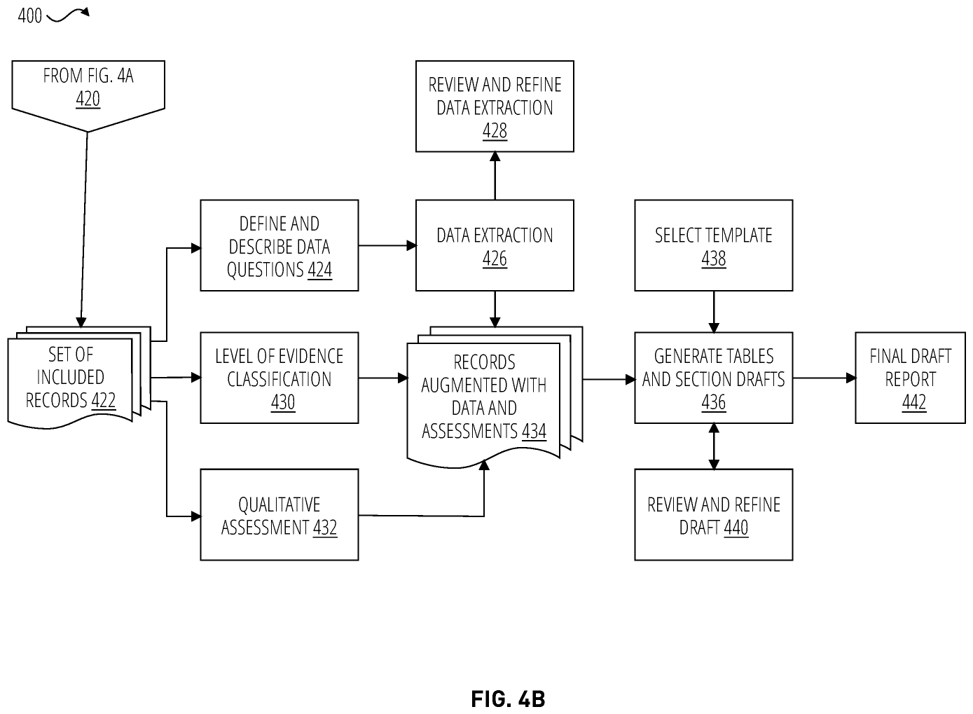

FIGS. 4A and 4B illustrate a process flow 400 an SLR system according to some embodiments. The process flow 400 may be performed by processing logic that may include hardware and/or control logic (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of process flow 400 may be performed by one or more components of SLR system 302. Embodiments are not limited in this context.

With reference to FIGS. 4A and 4B, process flow 400 illustrates example functions and components used by various embodiments. Although specific function and component blocks (“blocks”) are disclosed in process flow 400, such blocks are examples. That is, embodiments are well suited to performing various other blocks or variations of the blocks recited in process flow 400. It is appreciated that the blocks in process flow 400 may be performed in an order different than presented, and that not all of the blocks in process flow 400 may be performed.

Referring to FIG. 4A, process flow 400 begins at block 402, where a project (e.g., a systematic literature review) is started. For example, user device 304 may be utilized to log into the SLR system 302 and project manager 308 may provide functionality to enable the user to start a new project, such as by providing input via GUI 326. Continuing to block 404, the aim, framework, and databases for the project may be defined. For example, parameterizer 310 may present a series of questions on user device 304 via GUI 326 to enable a user to define the aim, framework (e.g., review protocol), and databases to search for the project. In some embodiment, additional parameters may be provided at block 404, such as thresholds. In various embodiments, the parameterizer 310 may provide suggested responses to one or more of the questions. For example, parameterizer 310 may suggest a framework based on the aim of the project. In another example, the parameterizer 310 may suggest one or more databases to search based on the aim and/or framework of the project. In some embodiments, parameterizer 310 may analyze previous inputs and projects performed to determine the suggested responses. For example, the parameterizer 310 may determine the most common responses previously provided and utilize them as suggested responses.

At block 406 suggested queries may be determined. For example, query generator 312 may generate one or more suggested database queries based on parameters provided at block 404. In many embodiments, the query generator 312 may utilize an AI model, such as a large language model to generate the database queries. In many such embodiments, the parameters provided at block 404 may be incorporated into a template prompt specifically engineered to obtain useful database queries. For example, the prompt may be engineered to utilize one or more of phrasing of the query, specifying a style, providing relevant context, and assigning a role to the AI model. For example, the role assigned to the AI model in the prompt may include “an expert in querying databases to identify data related to {insert aim of the study} upon which to base performance of a systematic literature review”. Proceeding to block 408, the suggested database queries may be presented to a user, such as via GUI 326 of user device 304 for confirmation and testing. In various embodiments, testing may include presenting sample results of one or more of the suggested and approved queries obtained from databases 410. In many embodiments, determining the queries may be an interactive process in which a user may modify suggested queries. In many such embodiments, the SLR system 302 may learn from the modifications to improve future suggested queries. For example, the query generator 312 may utilize user input to label training data and the labeled training data may be utilized to produce an updated AI model. The query generator 312 may then utilize the final queries to obtain a set of related records from databases 410.

Once the set of related records are obtained from databases 410, the process flow 400 may proceed to block 412 where title and abstract screening is performed. For example, screener 316 may perform title and abstract screening to determine a set of relevant records from the set of related records. At block 414, a suggested set of relevant records may be presented to the user, such as via GUI 326 of user device 304 for review and refining. As with other stages of performing a systematic literature review project with SLR system 302, the review and refining process may be an interactive process in which a user may modify the suggested set of related records. Further, the SLR system 302 may learn from the modifications to improve future suggested sets of related records. In various embodiments, the review and refine processes described hereby may result in an improved user interface. For example, review and refine processes may provide summaries of relevant previously utilized inputs and provide users with functionality to readily implement previously utilized inputs. In another example, functions may be surfaced during the review and refine processes, such as a function to edit predefined templates, settings, and/or parameters in response to user modifications or a threshold of user modification. In one instance, if a user edits a portion of a predefined template during a review and refine process, the system may automatically surface functionality to enable the user to adjust the predefined template accordingly without having to exit the review and refine process. In another instance, if a user edits a parameter of a systematic literature project during a review and refine process, the system may automatically surface functionality to enable the user to cause the system to automatically update one or more other aspects of the systematic literature review project that rely on the modified parameter.

Proceeding to block 416, a full text screening of the suggested set of related records may be performed in the same or similar manner as the title and abstract screening, including a review and refining process at block 418. More generally, the screening process of process flow 400 including blocks 412, 414, 416, 418 may be utilized to reduce the set of related records obtained from databases 410 to a set of relevant records, also referred to as the set of included records, upon which to base the systematic literature review project. After screening has been performed, the process flow 400 may proceed, at block 420, to FIG. 4B.

Referring to FIG. 4B, process flow 400 continues from block 420 to block 422, where the set of included records (i.e., the set relevant records remaining from the set of related records after screening) are provided to blocks 424, 430, 432 for further processing in performance of the systematic literature review project. At block 424 data questions are defined and described. For example, the data extractor 322 may operate to determine a list of questions (e.g., concepts) that need to be answered for each record, such as “What is the aim of the study?” and/or “What are the findings on prevalence of childhood bereavement?”. In various embodiments, the questions may be determined based on user input. Description of the data questions may include determining indications from where to draw the information, such as sections. In several embodiments, the data extractor 322 may present suggested data questions and/or suggested indications from where to draw the information to a user, such as via GUI 326 of user device 304. In many embodiments, determination of the list of questions and the indications from where to draw the information may proceed in a manner that is the same or similar to determination of the suggested queries at block 406. The process flow 400 may then proceed to block 426 where data extraction is performed. For example, data extractor 322 may extract answers to the list of questions for each of the records in the set of relevant records. This process, which was described in more detail above with respect to FIG. 3, may be performed in the same or similar manner as the title and abstract screening, including a review and refining process at block 428.

The set of included records may also be provided for level of evidence classification at block 430 and qualitative assessment at block 432. The level of evidence classification may be performed by the EQ analyzer 320 as described in more detail above with respect to FIG. 3. Similarly, the qualitative assessment may be performed by the EQ analyzer 320 as described in more detail above with respect to FIG. 3. The outputs of the data extraction at block 426, the level of evidence classification at block 430, and the qualitative assessment at block 432 may be output to form a set of records augmented with data and assessments at block 434. For example, the set of records augmented with data and assessments may be generated by data extractor 322 based on the data extraction process and the outputs of the EQ analyzer 320. In various embodiments, the set of records augmented with data and assessments may include a table or spreadsheet file generated by data extractor 322.

Proceeding to block 436, tables and section drafts may be generated. For example, report drafter 324 may generate tables and section drafts for the final draft report. At block 438 a template may be selected for the final draft report. For example, report drafter 324 may request and receive user input selecting a template for the final draft report. In many embodiments, the report drafter 324 may provide one or more suggested templates. In many such embodiments, the one or more suggested templates may be determined based on various parameters of the systematic literature review project and/or information included in the records augmented with data and assessments. Additionally, at block 440, a review and refinement process may be performed, which may be an interactive process that is the same or similar to other interactive processes previously described. After the final draft report is approved, it may be provided as output at block 442. For example, the final draft report may be provided to user device 304. Additionally, or alternatively, the final draft report may be provided to one or more other locations, such as an email account or another user device, for further analysis, such as a quality review. In some embodiments, the final draft report may be provided to a client device.

FIG. 5 illustrates various aspects of generating training data 506 and an AI model 510 for SLR systems according to some embodiments. The illustrated embodiment includes one or more data sources 502, a training data manager 504, training data 506, an AI model manager 508, and AI model 510. In various embodiments, the components of FIG. 5 may be utilized to generate training data 506 based on available data in data sources 502 and/or create an AI model 510 for performing systematic literature reviews based on the training data 506. In many embodiments, different AI models of one or more different types may be generated for different aspects of a systematic literature review. Further, the different AI models may be trained on different training data. It will be appreciated that one or more components of FIG. 5 may be the same or similar to one or more other components disclosed herein. For example, data sources 502 may be the same or similar to data resources 328. In another example, training data manager 504 and/or AI model manager 508 may be the same or similar to AI resources 330. Further, aspects discussed with respect to various components in FIG. 5 may be implemented by one or more other components from one or more other embodiments without departing from the scope of this disclosure. For example, one or more of the training data manager 504 and the AI model manager 508 may be incorporated into one or more components of SLR system 302 without departing from the scope of this disclosure. Embodiments are not limited in this context.

In many embodiments, the SLR systems disclosed hereby may utilize various artificial intelligence techniques to automate and/or assist in one or more aspects of performing a systematic literature review, also referred to as a project. For example, various AI models may be utilized in one or more of designing a search strategy, searching selected electronic databases, screening the records (e.g., articles, papers, etc.) sourced for inclusion, extracting relevant data from the records, and drafting a summary report. Integration of AI can increase speed and efficiency of systematic reviews without compromising quality. Additionally, many embodiments include a user interface (e.g., presented via user device 104) that can be used to generate interactive real-time systematic literature reviews in which a user can retain oversight of search parameters.

The data sources 502 may include various sets of information relevant to various aspects of performing a systematic literature review. For example, data sources 502 may include various existing systematic literature reviews or aspects thereof, such as parameters, record queries, data extraction questions, final reports, screening questions, and the like. In some embodiments, training data manager 504 may generate one or more portions of the information in data sources 502. For example, after completion of a systematic literature review project, the parameters, record queries, data extraction questions, final reports, screening questions may be stored in data sources 502. In many embodiments, this information may be grouped by type (e.g., parameters, record queries, data extraction questions, final reports, etc.). Additionally, the training data manager 504 may utilize user input to revise or label training data. For example, modifications to record queries may be utilized to update or label previous record queries in data sources 502.

In various embodiments, training data manager 504 may utilize data sources 502 to produce training data 506 for an AI model. For example, if an AI model for producing suggested record queries is to be generated by AI model manager 508, the training data manager 504 may identify and format the relevant data in data sources 502 to produce a training dataset for the AI model manager 508 to utilize in producing the AI model. In many embodiments, the training dataset may be created based on the type of the AI model to be produced and/or the purpose of the AI model. In various embodiments, a training data 506 may include one or more of a training dataset, a validation dataset, and a test dataset.

The AI model manager 508 may utilize the training data 506 to produce AI model 510. In many embodiments, the AI model manager 508 may produce different models for different aspects of the systematic literature review. For example, one or more of a first model may be produced for generating suggested record queries, a second model may be produced for making inclusion/exclusion determinations for title and abstract screening, a third model may be produced for making inclusion/exclusion determinations for full text screening, a fourth model may be produced for generating suggested data extraction questions, a fifth model may be produced for performing data extraction, a sixth model may be produced for performing level of evidence classifications, a seventh model may be produced for performing qualitative assessments, and an eighth model may be produced for generating draft reports. Production of the models may utilize supervised, semi-supervised, or unsupervised learning. For example, classification models may utilize supervised learning. In another example, large language models may utilize unsupervised learning and/or in-context learning.

Further, the different models may be different types, such as one or more of a large language model, a Bayes classifier, a generative pretrained transformer, an artificial neural network, a machine learning model, a deep learning model, a convolutional neural network, a recurrent neural network, a generative adversarial network, a support vector machine, a random forest, a classification model, and the like. For example, a generative pretrained transformer model may be utilized for data extraction and a classification model may be utilized for level of evidence classifications. In some embodiments, a model may be trained either to predict how the segment continues, or what is missing in the segment, given a segment from its training dataset. For example, a model trained to predict how a segment continues may be utilized for report draft generating models. In another example, a model trained to predict what is missing in a segment may be utilized to produce suggested record queries based on one or more template record queries.

More generally, a model may be initially fit using a training data set. The training dataset may include a set of examples used to fit the parameters (e.g. weights of connections between neurons in artificial neural networks) of the model. In some embodiments, the model (e.g. a Bayes classifier) may be trained on the training dataset using a supervised learning method, for example using optimization methods such as gradient descent or stochastic gradient descent. The training dataset may include pairs of an input vector or scalar and the corresponding output vector (or scalar). Further, an answer key may be denoted as the target or label. For example, data inserted into a template may be identified as the target or label.

During training, a current model can be run with the training dataset to produce a result, which is then compared with the target, for each input vector in the training data set. Based on the result of the comparison and the specific learning algorithm being used, the parameters of the model are adjusted. In various embodiments, model fitting can include both variable selection and parameter estimation. Iteratively, the fitted model is used to predict the responses for the observations in the validation data set. The validation data set provides an unbiased evaluation of a model fit on the training data set while tuning the hyperparameters of the model, such as the number of hidden units, layers, and/or layer widths in a neural network. The validation dataset may be used for regularization by early stopping, such as when the error on the validation data set increases, which can be a sign of over-fitting to the training data set. Finally, the test data set may be used to provide an unbiased evaluation of a final model fit on the training data set.

For classification tasks, a supervised learning algorithm may utilize the training dataset to determine an optimal combinations of variables that generate a predictive model that is able to classify previously unknown data. Large language models, which include generative pretrained transformer models, may be trained on large data sets of unlabeled text. For example, large language models for data extraction may be trained on a corpus of available academic literature. LLMs are pattern completion programs: They generate text by outputting the words most likely to come after the previous ones. They learn these patterns from their training data. In various embodiments, reinforcement learning from human feedback may be utilized. For example, a reward model may be trained from user input and the model may be used as a reward function to optimize a policy using reinforcement learning (RL) through an optimization algorithm like proximal policy optimization.

Many embodiments disclosed hereby utilize transformer models for tasks such as question answering, extraction and classification. More specifically, GPT with large context (input) windows may be utilized. In some embodiments, supervised learning and fine-tuning of models may be utilized for screening, but other tasks may utilize in-context learning, which includes zero and few-shot learning. Many of the example prompts provided herein may utilize zero-shot learning, in which the model is only given an abstract problem description or question without any examples. However, in general, all of these approaches are valid and can be applied to any step of the processes as long as sufficient training examples for the models are provided. In various portions of a systematic literature review, such as screening, machine learning approaches with lower resource demands, such as one or more of decision trees, naive bayes, random forest, support vector machine, logistic regression, and smaller neural networks (transformers are also neural networks but very big and expensive ones in terms of compute) may be used to classify examples based on a set of extracted features. Further, these may be combined with other approaches by using GPT models to first extract relevant features that are then classified in an active learning loop by cheaper and faster models. In some embodiments, models with high resource and cost requirements (e.g., LLMs), may be utilized to create training example with zero or few-shot learning and then these examples may be used to train smaller and cheaper models, so that they might be able to reach similar performance levels with less resource demands.

FIG. 6 illustrates a process flow 600 for data extraction by an SLR system according to some embodiments. The process flow 600 may be performed by processing logic that may include hardware and/or control logic (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of process flow 600 may be performed by one or more components of SLR system 302, such as data extractor 322. Embodiments are not limited in this context.

With reference to FIG. 6, process flow 600 illustrates example functions used by various embodiments. Although specific function blocks (“blocks”) are disclosed in process flow 600, such blocks are examples. That is, embodiments are well suited to performing various other blocks or variations of the blocks recited in process flow 600. It is appreciated that the blocks in process flow 600 may be performed in an order different than presented, and that not all of the blocks in process flow 600 may be performed.

Process flow 600 begins at block 602, where data extraction questions are defined. For example, data extractor 322 may operate to determine a list of questions (e.g., concepts) that need to be answered for each record, such as “What is the aim of the study?” and/or “What are the findings on prevalence of childhood bereavement?”. In various embodiments, the questions may be determined based on user input. In some embodiments, the data extraction questions may be defined in an interactive process. In some such examples, the data extractor 322 may determine suggested data questions based on various parameters of a systematic literature review project. For example, the data extractor 322 may utilize the subject of the aim of the project to produce suggested data extraction questions. In such examples, the data extractor 322 may insert the subject of the aim into a template question, such as “What are the finding on {subject}?”. For instance, if “What does existing research indicate regarding the prevalence childhood bereavement?” is the aim of a project, a suggested data extraction question may include “What are the findings on prevalence of childhood bereavement?”. In another example, the data extractor 322 may provide one or more predefined suggested data extraction questions, such as “What is the aim of the study?”. In various embodiments, the predefined suggested data extraction questions may be configured based on user input, such as via interaction with project manager 308. More generally, any predefined values utilized by an SLR system may be configured via the project manager 308.

Proceeding to block 606, a set of included records may be received. For example, the records remaining after the screening process (e.g., the relevant records) may be provided to data extractor 322. At block 608 the text may be extracted from each of the included studies. For example, a text extractor sub-component of data extractor 322 may read record files in the collection and extract raw text content. Proceeding to block 610, the text may be segmented into sections. For example, a text segmenter sub-component of data extractor 322 may divide the extracted text into different sections (e.g., applicable ones of the normalized set of sections) according to the structure of the records. In many embodiments, the segmentation process involves identifying section titles within the text and mapping them to predefined section names, such as title, abstract, findings, discussion, results, etc.).

At block 612 a prompt may be generated for each question with corresponding sections. For example, an AI prompt generator sub-component of data extractor 322 may utilize the segmented text to generate prompts for an AI model (e.g., generative pretrained transformer (GPT) model. In many embodiments, the prompts may include the segmented text of the corresponding (i.e., indicated) sections as described in more detail above with respect to FIG. 3. Continuing to block 614, the prompts may be provided to the AI model. For example, data extractor 322 may provide the prompts to AI resources 330 of remote resources 306 via resource interface 318. In various embodiments, the resource interface 318 may format or condition the input to the AI resources 330 into a format that is readily utilized by the AI resources 330, such as by vectorizing. The AI resources 330 may include the AI model that generates responses to the prompts.

Continuing to block 616, responses to the data extraction questions may be received. For example, data extractor 322 may receive output of the AI resources 330 via resource interface 318. In some embodiments, the resource interface 318 may format or condition the output of the AI resources 330 into a format that is readily utilized by data extractor 322. At block 618, the responses may be compiled into a dataset. For example, a results compiler sub-component of data extractor 322 may compile and organize the AI-generated answers according to the record file they came from and the question they answer. The results can then be saved to a table or spreadsheet file for easy review and analysis. Additionally, level of evidence classifications and/or qualitative assessment results (e.g., generated by EQ analyzer 320) may be included in the file. At block 620 the file may be stored. For example, the file may be stored in a location accessible by report drafter 324. In some embodiments, the file may be stored in one or more remote locations, such as in remote resources 306.

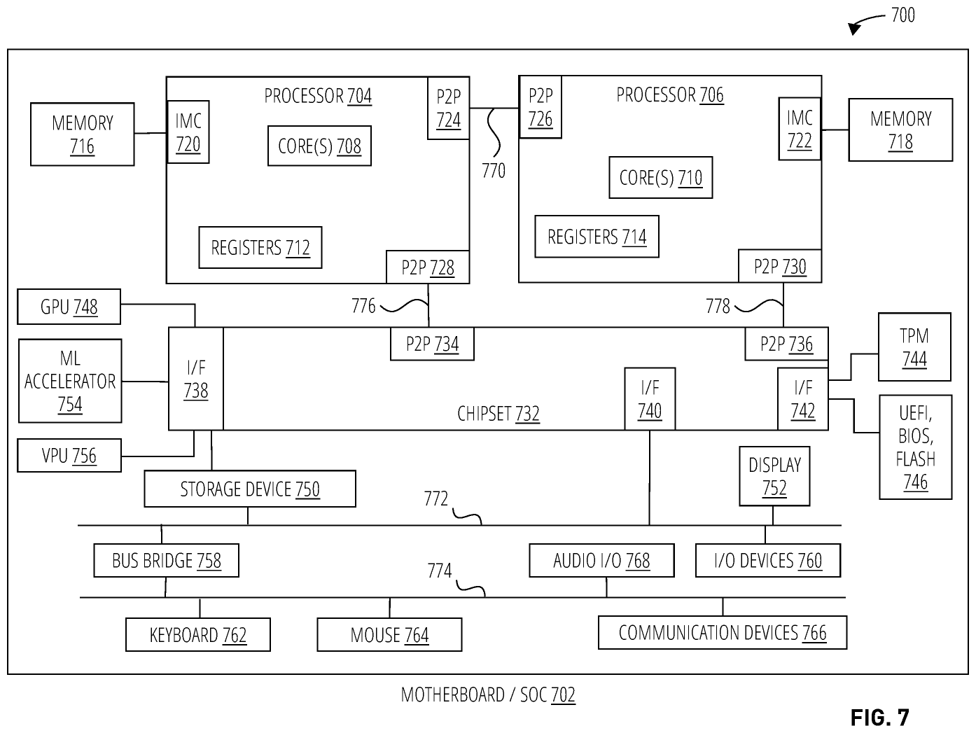

FIG. 7 illustrates an embodiment of a system 700 that may be suitable for implementing various embodiments described hereby. System 700 is a computing system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 700 may have a single processor with one core or more than one processor. Note that the term “processor” refers to a processor with a single core or a processor package with multiple processor cores. In at least one embodiment, the computing system 700, or one or more components thereof, is representative of one or more components described hereby, such as processing device 110, SLR system 302, user device 304, remote resources 306, training data manager 504, and/or AI model manager 508. More generally, the computing system 700 may be configured to implement embodiments including logic, systems, logic flows, process flows, methods, apparatuses, and functionality described hereby. The embodiments, however, are not limited to implementation by the system 700.

As used in this application, the terms “system” and “component” and “module” are generally intended to refer to a computer-related entity, either hardware, a combination of hardware and software, software, or software in execution, examples of which are provided by the exemplary system 700. For example, a component can be, but is not limited to being, a process running on a processor, a processor, a hard disk drive, multiple storage drives (of optical, solid-state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

Although not necessarily illustrated, the computing system 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. Further, the computing system 700 may include or implement various articles of manufacture. An article of manufacture may include a non-transitory computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, encrypted code, and the like, implemented using any suitable high-level, low-level, object-oriented, visual, compiled, and/or interpreted programming language. Embodiments may also be at least partly implemented as instructions contained in or on a non-transitory computer-readable medium, which may be read and executed by one or more processors to enable performance of the operations described herein.

As illustrated in FIG. 7, the system 700 comprises a motherboard or system-on-chip (SoC) 702 for mounting platform components. Motherboard or system-on-chip (SoC) 702 is a point-to-point (P2P) interconnect platform that includes a first processor 704 and a second processor 706 coupled via a point-to-point interconnect 770 such as an Ultra Path Interconnect (UPI). In other embodiments, the system 700 may be of another bus architecture, such as a multi-drop bus. Furthermore, each of processor 704 and processor 706 may be processor packages with multiple processor cores including core(s) 708 and core(s) 710, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 704 and chipset 732. Some platforms may include additional components and some platforms may only include sockets to mount the processors and/or the chipset. Furthermore, some platforms may not have sockets (e.g. SoC, or the like).

The processor 704 and processor 706 can be any of various commercially available processors. Dual microprocessors, multi-core processors, and other multi-processor architectures may also be employed as the processor 704 and/or processor 706. Additionally, the processor 704 need not be identical to processor 706.

Processor 704 includes an integrated memory controller (IMC) 720 and point-to-point (P2P) interface 724 and P2P interface 728. Similarly, the processor 706 includes an IMC 722 as well as P2P interface 726 and P2P interface 730. IMC 720 and IMC 722 couple the processors processor 704 and processor 706, respectively, to respective memories (e.g., memory 716 and memory 718). Memories 716, 718 can store instructions executable by circuitry of system 700 (e.g., processor 704, processor 706, graphics processing unit (GPU) 748, ML accelerator 754, vision processing unit (VPU) 756, or the like). For example, memories 716, 718 can store instructions for one or more of project manager 308, parameterizer 310, query generator 312, screener 316, EQ analyzer 320, data extractor 322, report drafter 324, training data manager 504, AI model manager 508, and the like. In another example, memories 716, 718 can store data, such as SLR report 108, sets of included studies, training data 506, and the like. Memory 716 and memory 718 may be portions of the main memory (e.g., a dynamic random-access memory (DRAM)) for the platform such as double data rate type 3 (DDR3) or type 4 (DDR4) synchronous DRAM (SDRAM). In the present embodiment, the memory 716 and memory 718 locally attach to the respective processors (i.e., processor 704 and processor 706). In other embodiments, the main memory may couple with the processors via a bus and/or shared memory hub.

System 700 includes chipset 732 coupled to processor 704 and processor 706. Furthermore, chipset 732 can be coupled to storage device 750, for example, via an interface (I/F) 738. The I/F 738 may be, for example, a Peripheral Component Interconnect-enhanced (PCI-e). In many embodiments, storage device 750 comprises a non-transitory computer-readable medium. Storage device 750 can store instructions executable by circuitry of system 700 (e.g., processor 704, processor 706, GPU 748, ML accelerator 754, vision processing unit 756, or the like). For example, storage device 750 can store instructions for one or more of project manager 308, parameterizer 310, query generator 312, screener 316, EQ analyzer 320, data extractor 322, report drafter 324, training data manager 504, AI model manager 508, and the like. In another example, storage device 750 can store data, such as SLR report 108, sets of included studies, training data 506, and the like. In some embodiments, instructions may be copied or moved from storage device 750 to memory 716 and/or memory 718 for execution, such as by processor 704 and/or processor 706.

Processor 704 couples to a chipset 732 via P2P interface 728 and P2P interface 734 while processor 706 couples to a chipset 732 via P2P interface 730 and P2P interface 736. Direct media interface (DMI) 776 and DMI 778 may couple the P2P interface 728 and the P2P interface 734 and the P2P interface 730 and P2P interface 736, respectively. DMI 776 and DMI 778 may be a high-speed interconnect that facilitates, e.g., eight Giga Transfers per second (GT/s) such as DMI 3.0. In other embodiments, the components may interconnect via a bus.

The chipset 732 may comprise a controller hub such as a platform controller hub (PCH). The chipset 732 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 732 may comprise more than one controller hub such as a chipset with a memory controller hub, a graphics controller hub, and an input/output (I/O) controller hub.

In the depicted example, chipset 732 couples with a trusted platform module (TPM) 744 and UEFI, BIOS, FLASH circuitry 746 via I/F 742. The TPM 744 is a dedicated microcontroller designed to secure hardware by integrating cryptographic keys into devices. The UEFI, BIOS, FLASH circuitry 746 may provide pre-boot code.

Furthermore, chipset 732 includes the I/F 738 to couple chipset 732 with a high-performance graphics engine, such as, graphics processing circuitry or a graphics processing unit (GPU) 748. In other embodiments, the system 700 may include a flexible display interface (FDI) (not shown) between the processor 704 and/or the processor 706 and the chipset 732. The FDI interconnects a graphics processor core in one or more of processor 704 and/or processor 706 with the chipset 732.

Additionally, ML accelerator 754 and/or vision processing unit 756 can be coupled to chipset 732 via I/F 738. ML accelerator 754 can be circuitry arranged to execute ML related operations (e.g., training, inference, etc.) for ML models. Likewise, vision processing unit 756 can be circuitry arranged to execute vision processing specific or related operations. In particular, ML accelerator 754 and/or vision processing unit 756 can be arranged to execute mathematical operations and/or operands useful for machine learning, neural network processing, artificial intelligence, vision processing, etc.

Various I/O devices 760 and display 752 couple to the bus 772, along with a bus bridge 758 which couples the bus 772 to a second bus 774 and an I/F 740 that connects the bus 772 with the chipset 732. In one embodiment, the second bus 774 may be a low pin count (LPC) bus. Various I/O devices may couple to the second bus 774 including, for example, a keyboard 762, a mouse 764, and communication devices 766.

Furthermore, an audio I/O 768 may couple to second bus 774. Many of the I/O devices 760 and communication devices 766 may reside on the motherboard or system-on-chip (SoC) 702 while the keyboard 762 and the mouse 764 may be add-on peripherals. In other embodiments, some or all the I/O devices 760 and communication devices 766 are add-on peripherals and do not reside on the motherboard or system-on-chip (SoC) 702. More generally, the I/O devices of system 700 may include one or more of microphones, speakers, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, displays, augmented/virtual reality devices, printers, actuators, motors, transducers, and the like.

The system 700 and/or one or more components thereof may be utilized in a variety of different system environments, such as one or more of standalone, networked, remote-access (e.g., remote desktop), virtualized, and cloud-based environments.

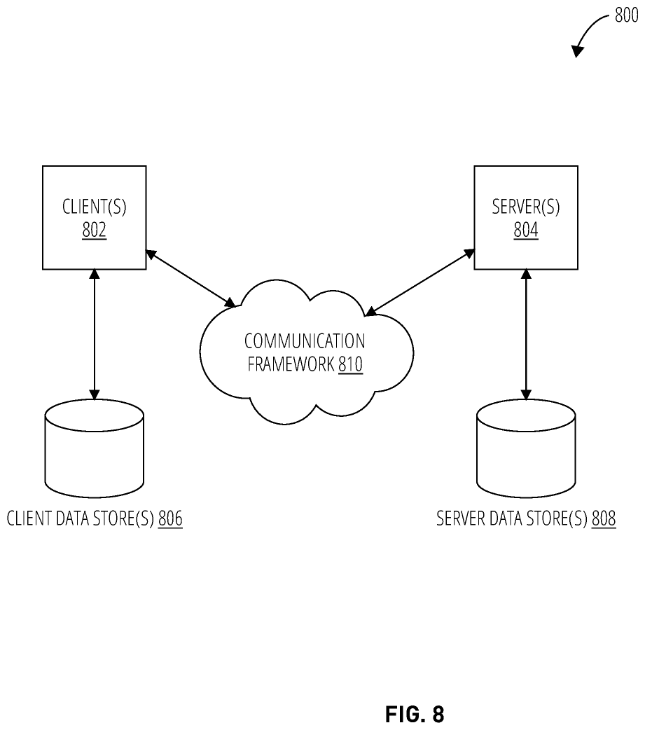

FIG. 8 is a block diagram depicting an exemplary communications architecture 800 suitable for implementing various embodiments as previously described, such as communications between one or more of SLR system 102, user device 104, and remote resources 106. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more client(s) 802 and server(s) 804. In some embodiments, each client 802 and/or server 804 may include a computing system (e.g., user device 104 or system 700) The server(s) 804 may implement one or more devices or components of SLR system 302 and/or remote resources 306. The client(s) 802 and the server(s) 804 are operatively connected to one or more respective client data store(s) 806 and server data store(s) 808 that can be employed to store information local to the respective client(s) 802 and server(s) 804, such as cookies and/or associated contextual information. In one embodiment, server data store(s) 808 may include data resources 328. In various embodiments, any one of server(s) 804 may implement one or more logic flows or operations described hereby, such as in conjunction with storage of data received from any one of client(s) 802 on any of server data store(s) 808. In one or more embodiments, one or more of client data store(s) 806 or server data store(s) 808 may include memory accessible to one or more portions of components, applications, and/or techniques described hereby.

The client(s) 802 and the server(s) 804 may communicate information between each other using a communication framework 810. The communication framework 810 may implement any well-known communications techniques and protocols. The communication framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount of speed and capacity, distributed network controller architectures may similarly be employed to pool, load balance, and otherwise increase the communicative bandwidth required by client(s) 802 and the server(s) 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate.

The various devices, components, modules, features, and functionalities described hereby may include, or be implemented via, various hardware elements, software elements, or a combination of both. Examples of hardware elements may include devices, logic devices, hardware components, processors, microprocessors, circuits, circuitry, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, algorithms, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation. It is noted that hardware, firmware, and/or software elements may be collectively or individually referred to herein as “logic”, “circuit”, or “circuitry”.

One or more aspects of at least one embodiment may be implemented by representative instructions stored on a machine-readable medium which represents various logic within the processor, which when read by a machine causes the machine to fabricate logic to perform the techniques described hereby. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

There are a number of example embodiments described herein.

Example 1 is a systematic review method, comprising: defining a literature research issue; determining one or more database search queries for identifying one or more literature records relevant to the literature research issue; searching one or more databases using the one or more database search queries to identify literature records therefrom relevant to the literature research issue; screening the relevant literature records to determine candidate literature records therefrom for inclusion in a systematic literature review; identifying data relevant to the literature research issue from the candidate literature records, identifying data including: defining one or more data queries for identifying the data relevant to the literature research issue; and deploying a machine learning model to: apply the one or more data queries to the candidate literature records to identify therein the data relevant to the literature research issue; associate an evidence level or a classification with the identified data; and perform a qualitative assessment of the identified data; and preparing a report including the identified data and an association thereof with the literature research issue.

Example 2 is the systematic review method of Example 1 that may optionally include that defining a literature research issue comprises defining an aim of the literature research issue, determining a PICOS framework of the literature research issue, and identifying the one or more databases having one or more literature records relevant to the literature research issue.

Example 3 is the systematic review method of Example 1 that may optionally include that screening the relevant literature records comprises: determining one or more key aspects of the literature research issue; for each key aspect, determining one or more sections of each relevant literature record in which to search for the key aspect; and identifying text from any literature record identified as corresponding to one of the key aspects.

Example 4 is the systematic review method of Example 1 that may optionally include that screening the relevant literature records comprises deploying a machine learning model to: determine one or more key aspects of the literature research issue; for each key aspect, determine one or more sections of each relevant literature record in which to search for the key aspect; and identify text from any literature record identified as corresponding to one of the key aspects.

Example 5 is the systematic review method of Example 1 that may optionally include that screening the relevant literature records comprises: determining one or more key aspects of the literature research issue; for each key aspect, performing a full text search of each relevant literature record for the key aspect; and identifying text from any literature record identified as corresponding to one of the key aspects.

Example 6 is the systematic review method of Example 1 that may optionally include that screening the relevant literature records comprises deploying a machine learning model to: determine one or more key aspects of the literature research issue; for each key aspect, perform a full text search of each relevant literature record for the key aspect; and identify text from any literature record identified as corresponding to one of the key aspects.

Example 7 is the systematic review method of Example 1 that may optionally include that identifying data by deploying the machine learning model comprises normalizing the identified data across the candidate literature records.

Example 8 is the systematic review method of Example 1 that may optionally include annotating each candidate literature record with the identified data, the evidence level of the identified data, the classification of the identified data, or the qualitative assessment of the identified data.

Example 9 is the systematic review method of Example 1 that may optionally include that preparing the report comprises selecting a report template corresponding to a PICOS framework of the literature research issue.

Example 10 is the systematic review method of Example 1 that may optionally include that preparing the report comprises deploying a machine learning model to: compile the identified data; generate a description of the compiled identified data; and generate content for one or more sections of the report, based on the association of the identified data with the literature research issue.

Example 11 is an apparatus comprising one or more processors configured to perform the method of any one of claims 1 to 10.

Example 12 is a non-transitory machine-readable medium having executable instructions to cause one or more processing devices to perform the method of any one of claims 1 to 10.

Example 13 is a computer-implemented method comprising: identifying a record associated with a systematic literature review; generating, with a processing device, a normalized set of sections included in the record; determining, with the processing device, a question pertaining to the systematic literature review; determining, with the processing device, an indication of at least one section of the normalized set of sections to evaluate in responding to the question; determining, with the processing device, a role for responding to the question; transforming, with the processing device, the question, content of the at least one section of the normalized set of sections, and the role for responding to the question into a prompt for an artificial intelligence model, the prompt configured to cause the AI model to assume the role and generate a response to the question as output based on the content of the at least one section of the normalized set of sections; providing, via an interface, the prompt to the AI model; and updating, with the processing device, a record file stored in computer memory to include at least a portion of the output of the AI model as an answer to the question that is associated with the record.

Example 14 is the computer-implemented method of Example 13 that may optionally include evaluating at least one of a framework of the record, interpretations in the record, conclusions in the record, assumptions in the record, and a source of the record to perform a qualitative assessment of the record; determining a quality score of the record based on the qualitative assessment; and updating the record file stored in the computer memory to include the quality score.

Example 15 is the computer-implemented method of Example 14 that may optionally include identifying a risk of bias associated with the record based on the qualitative assessment of the record; and determining the quality score of the record based on the risk of bias.

Example 16 is the computer-implemented method of Example 13 that may optionally include performing a level of evidence classification to determine a trustworthiness of the record; and updating the record file stored in the computer memory to include an indication of the trustworthiness of the record.

Example 17 is the computer-implemented method of Example 13 that may optionally include determining an aim of the systematic literature review based on input provided via a graphical user interface.

Example 18 is the computer-implemented method of Example 17 that may optionally include that determining the question pertaining to the systematic literature review is based on the aim of the systematic literature review.

Example 19 is the computer-implemented method of Example 17 that may optionally include that determining the role for responding to the question is based on the aim of the systematic literature review.

Example 20 is the computer-implemented method of Example 19 that may optionally include that the role for responding to the question comprises an expert in querying databases to identify data related to the aim of the systematic literature review.

Example 21 is the computer-implemented method of Example 13 that may optionally include that the prompt comprises a first prompt and the one or more processors are further configured to perform operations comprising: generating a second prompt to perform a qualitative assessment of the record, wherein the qualitative assessment evaluates at least one of a framework of the record, interpretations in the record, conclusions in the record, assumptions in the record, and a source of the record to; providing, via the interface, the second prompt to the AI model; determining a quality score of the record based on the qualitative assessment output by the AI model; and updating the record file stored in the computer memory to include the quality score.

Example 22 is the computer-implemented method of Example 21 that may optionally include that the one or more processors are further configured to perform operations comprising: identifying a risk of bias associated with the record based on the qualitative assessment of the record; and determining the quality score of the record based on the risk of bias.

Example 23 is the computer-implemented method of Example 13 that may optionally include that the prompt comprises a first prompt and one or more processors are further configured to perform operations comprising: generating a second prompt to perform a level of evidence classification of the record to determine a trustworthiness of the record; providing, via the interface, the second prompt to the AI model; and updating the record file stored in the computer memory to include an indication of the trustworthiness of the record.

Example 24 is an apparatus comprising one or more processors configured to perform the method of any one of claims 13 to 23.

Example 25 is a non-transitory machine-readable medium having executable instructions to cause one or more processing devices to perform the method of any one of claims 13 to 23.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method comprising:
identifying a record associated with a systematic literature review;
generating, with a processing device, a normalized set of sections included in the record;
determining, with the processing device, a question pertaining to the systematic literature review;
determining, with the processing device, an indication of at least one section of the normalized set of sections to evaluate in responding to the question;
determining, with the processing device, a role for responding to the question;
transforming, with the processing device, the question, content of the at least one section of the normalized set of sections, and the role for responding to the question into a prompt for an artificial intelligence model, the prompt configured to cause the AI model to assume the role and generate a response to the question as output based on the content of the at least one section of the normalized set of sections;
providing, via an interface, the prompt to the AI model; and
updating, with the processing device, a record file stored in computer memory to include at least a portion of the output of the AI model as an answer to the question that is associated with the record.

2. The computer-implemented method of claim 1, further comprising:
evaluating at least one of a framework of the record, interpretations in the record, conclusions in the record, assumptions in the record, and a source of the record to perform a qualitative assessment of the record;
determining a quality score of the record based on the qualitative assessment; and
updating the record file stored in the computer memory to include the quality score.

3. The computer-implemented method of claim 2, further comprising:
identifying a risk of bias associated with the record based on the qualitative assessment of the record; and
determining the quality score of the record based on the risk of bias.

4. The computer-implemented method of claim 1, further comprising:
performing a level of evidence classification to determine a trustworthiness of the record; and
updating the record file stored in the computer memory to include an indication of the trustworthiness of the record.

5. The computer-implemented method of claim 1, further comprising determining an aim of the systematic literature review based on input provided via a graphical user interface.

6. The computer-implemented method of claim 5, wherein determining the question pertaining to the systematic literature review is based on the aim of the systematic literature review.

7. The computer-implemented method of claim 5, wherein determining the role for responding to the question is based on the aim of the systematic literature review.

8. The computer-implemented method of claim 7, wherein the role for responding to the question comprises an expert in querying databases to identify data related to the aim of the systematic literature review.

9. An apparatus comprising one or more processors configured to perform operations comprising:
identifying a record associated with a systematic literature review;
generating, with a processing device, a normalized set of sections included in the record;
determining, with the processing device, a question pertaining to the systematic literature review;
determining, with the processing device, an indication of at least one section of the normalized set of sections to evaluate in responding to the question;
determining, with the processing device, a role for responding to the question;
transforming, with the processing device, the question, content of the at least one section of the normalized set of sections, and the role for responding to the question into a prompt for an artificial intelligence model, the prompt configured to cause the AI model to assume the role and generate a response to the question as output based on the content of the at least one section of the normalized set of sections;
providing, via an interface, the prompt to the AI model; and
updating, with the processing device, a record file stored in computer memory to include at least a portion of the output of the AI model as an answer to the question that is associated with the record.

10. The apparatus of claim 9, wherein the prompt comprises a first prompt and one or more processors are further configured to perform operations comprising:
generating a second prompt to perform a qualitative assessment of the record, wherein the qualitative assessment evaluates at least one of a framework of the record, interpretations in the record, conclusions in the record, assumptions in the record, and a source of the record to;
providing, via the interface, the second prompt to the AI model;
determining a quality score of the record based on the qualitative assessment output by the AI model; and
updating the record file stored in the computer memory to include the quality score.

11. The apparatus of claim 10, wherein the one or more processors are further configured to perform operations comprising:
identifying a risk of bias associated with the record based on the qualitative assessment of the record; and
determining the quality score of the record based on the risk of bias.

12. The apparatus of claim 9, wherein the prompt comprises a first prompt and one or more processors are further configured to perform operations comprising:
generating a second prompt to perform a level of evidence classification of the record to determine a trustworthiness of the record;
providing, via the interface, the second prompt to the AI model; and
updating the record file stored in the computer memory to include an indication of the trustworthiness of the record.

13. The apparatus of claim 9, wherein the one or more processors are further configured to perform operations comprising determining an aim of the systematic literature review based on input provided via a graphical user interface.

14. The apparatus of claim 13, wherein determining the question pertaining to the systematic literature review is based on the aim of the systematic literature review.

15. apparatus of claim 13, wherein determining the role for responding to the question is based on the aim of the systematic literature review.

16. The apparatus of claim 15, wherein the role for responding to the question comprises an expert in querying databases to identify data related to the aim of the systematic literature review.

17. A non-transitory machine-readable medium having executable instructions to cause one or more processing units to perform a method, the method comprising:
identifying a record associated with a systematic literature review;
generating, with a processing device, a normalized set of sections included in the record;
determining, with the processing device, a question pertaining to the systematic literature review;
determining, with the processing device, an indication of at least one section of the normalized set of sections to evaluate in responding to the question;
determining, with the processing device, a role for responding to the question;
transforming, with the processing device, the question, content of the at least one section of the normalized set of sections, and the role for responding to the question into a prompt for an artificial intelligence model, the prompt configured to cause the AI model to assume the role and generate a response to the question as output based on the content of the at least one section of the normalized set of sections;
providing, via an interface, the prompt to the AI model; and
updating, with the processing device, a record file stored in computer memory to include at least a portion of the output of the AI model as an answer to the question that is associated with the record.

18. The non-transitory machine-readable medium of claim 17, the non-transitory machine-readable medium having instructions to cause one or more processing units to perform the method further comprising:
evaluating at least one of a framework of the record, interpretations in the record, conclusions in the record, assumptions in the record, and a source of the record to perform a qualitative assessment of the record;
determining a quality score of the record based on the qualitative assessment; and
updating the record file stored in the computer memory to include the quality score.

19. The non-transitory machine-readable medium of claim 18, the non-transitory machine-readable medium having instructions to cause one or more processing units to perform the method further comprising:
identifying a risk of bias associated with the record based on the qualitative assessment of the record; and
determining the quality score of the record based on the risk of bias.

20. The non-transitory machine-readable medium of claim 17, the non-transitory machine-readable medium having instructions to cause one or more processing units to perform the method further comprising:
performing a level of evidence classification to determine a trustworthiness of the record; and
updating the record file stored in the computer memory to include an indication of the trustworthiness of the record.
